(19) United States
(12) Patent Application Publication
(10) Pub. No.: US 2011/0126483 A1
(43) Pub. Date: Jun. 2, 2011

(54) DECORATIVE TILE KIT

(76) Inventor: JOSE IGNACIO GARCIA DORADO, Miami, FL (US)

(21) Appl. No.: 12/627,597

(22) Filed: Nov. 30, 2009

(51) Int. Cl. E04F 13/07; B44F 11/04

(52) U.S. Cl. 52/311.2

(57) ABSTRACT

A decorative tile kit having at least a set of two tiles, each tile being identical, but for the fact that the elevation or color defined within each tile is inverted. The kit is used by fixedly placing tiles on a surface so that geometric figures are defined on the surface in accordance to the user's preference. The kit of the present invention creates shapes which depict waves, flowers, fans, tears, or other designs.

### BACKGROUND

The present invention relates to the field of decorative tiles for walls and floors, and more specifically, to tiles used to create mosaic structures.

The inventor has always been fascinated with creating patterns on flat structures. He always dreamed of using tiles to create mosaic structures. In the present market, the cost of using tiles to create mosaic structures can be astronomical.

The costs associated with creating tile mosaic structures is what drove the present inventor to develop a decorative tile kit that would be cost efficient to produce and distribute, while at the same time lending themselves to be aesthetically pleasing.

He came up with a decorative tile kit having a specific design that could create a diversity of patterns using either color or elevation, while keeping the cost of the kit to a minimum.

The tile kit that he created can be easily manipulated to create different designs on flat surfaces; producing an aesthetically pleasing result.

For the foregoing reasons, there is a need for a decorative tile kit used to create mosaic tile structures that can be easily manipulated and that is cost efficient to produce.

### SUMMARY

The present invention is directed to a decorative tile kit that allows users to create mosaic structures at a reduced cost.

The decorative tile kit of the present invention is comprised of at least a set of two tiles, each tile being identical, but for the fact that the elevation or color defined within each tile is inverted. The kit is used by fixedly placing tiles on a surface so that geometric figures are defined on the surface in accordance to the user's preference. The kit of the present invention creates shapes which can form waves, petals, flowers, fans, tears, or other designs.

The decorative tile kit can be used to make three dimensional mosaic images when using tiles having different elevations on walls.

The decorative tile kit having different colors but same elevations is preferably used on floors, but can also be used on walls. It is foreseen that the decorative tile kit can be installed using tiles with different elevations and colors.

An object of the present invention is to provide a decorative tile kit that will allow the user to create mosaic patterns on wall or floors.

Another object of the present invention is to provide a decorative tile kit for creating mosaic patterns on walls and floors that is inexpensive to produce.

### DRAWINGS

These and other features, aspects, and advantages of the present invention will become better understood with regard to the following description, appended claims, and drawings where:

FIG. 1 is a drawing showing a top plan view of a first tile of the present invention;

FIG. 1A is a drawing showing top plan view of a second tile of the present invention;

FIG. 2 is a drawing showing a top plan view of a grouping of at least two first tiles and two second tiles to create a petal mosaic structure;

FIG. 3 is a drawing showing a top plan view of a grouping of at least two second tiles and two first tiles to create a negative of the mosaic structure shown in FIG. 2;

FIG. 4 is a drawing showing a mosaic structure using a grouping of tile sets, using the tile sets described in FIG. 2, to show an example of how a surface may be decorated;

FIG. 5 is a drawing showing a top plan view of a grouping of at least four second tiles to form a flower mosaic structure;

FIG. 6 is a drawing showing a top plan view of a grouping of a second, a first, and another second tile to form a half bell petal mosaic structure;

FIG. 7 is a drawing showing a top plan view of a grouping of a second, a first, another first, and another second tile to form an L-shaped mosaic structure using the half bell petal structures of FIG. 6; and

FIG. 8 is a drawing showing a top plan view of various mosaic structures using the present invention.

### DESCRIPTION

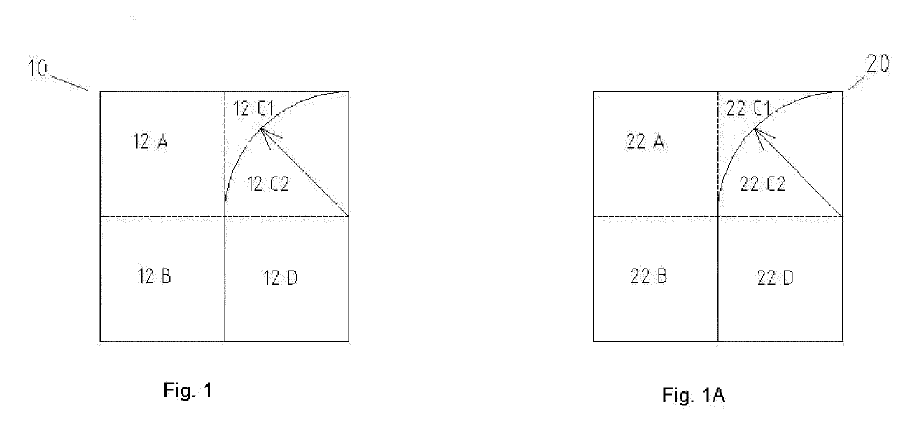

As seen in FIGS. 1-1a, A decorative tile kit comprises of at least a first tile and of at least of a second tile.

The first tile 10 has four quadrants, the quadrants are a top right 12C1/12C2, a top left 12A, a bottom right 12D, and a bottom left 12B. The top left 12A and bottom left 12B quadrants have a first solid physical characteristic. The top right quadrant 12C1/12C2 has a first design having two physical characteristics. The first design is a radius curve that is measured from a bottom right corner of the top right quadrant 12C1/12C2. The radius curve divides the top right quadrant 12C1/12C2 so that the quadrant has an inner 12C1 and an outer side 12C2 with respect to the top right quadrant 12C1/12C2. The inner side 12C1 of the top right quadrant 12C1/12C2 has a physical characteristic that is the same as the first solid physical characteristic of the top left 12A and bottom left quadrants 12B. The outer side 122C2 of the top right quadrant 12C1/12C2 has a second physical characteristic that is different from the first solid physical characteristic. The bottom right quadrant 12D has a solid physical characteristic that is the same as the second physical characteristic of the outer side 12C2 of the top right quadrant 12C1/12C2.

The second tile 20 has four quadrants, the quadrants are a top right 22C1/22C2, a top left 22A, a bottom right 22D, and a bottom left 22B. The top left 22A and bottom left 22D quadrants have a third solid physical characteristic. The third solid physical characteristic is the same as the second physical characteristic of the outer side 12C2 of the top right quadrant of the first tile 10. The top right quadrant 22C1/22C2 has a second design having two physical characteristics. The second design is a radius curve that is measured from a bottom right corner of the top right quadrant 22C1/22C2. The radius curve divides the top right quadrant 22C1/22C2 so that the quadrant has an inner 22C1 and an outer 22C2 side with respect to the top right quadrant 22C1/22C2. The inner side 22C1 of the top right quadrant 22C1/22C2 has a physical characteristic that is the same as the third solid physical characteristic of the top left 22A and bottom left 22D quadrants. The outer side 22C2 of the top right quadrant 22C1/22C2 has a fourth physical characteristic that is different from the third physical characteristic, yet is the same as the first physical characteristic of the first tile 10. The bottom right quadrant 22D of the second tile 20 has a solid physical characteristic that is the same as the fourth physical characteristic of the outer side of the top right 22C2 quadrant of the second tile.

In an embodiment of the present invention, the first and fourth physical characteristics is a first color and wherein the second and third physical characteristics is a second color.

In another embodiment of the present invention, the first and fourth physical characteristics is a first elevation and wherein the second and third physical characteristics is a second elevation.

The tiles of the present invention are laid on a structure using known means in the art of laying tiles on a surface. The tile decorative kit can be used on floors as well as walls.

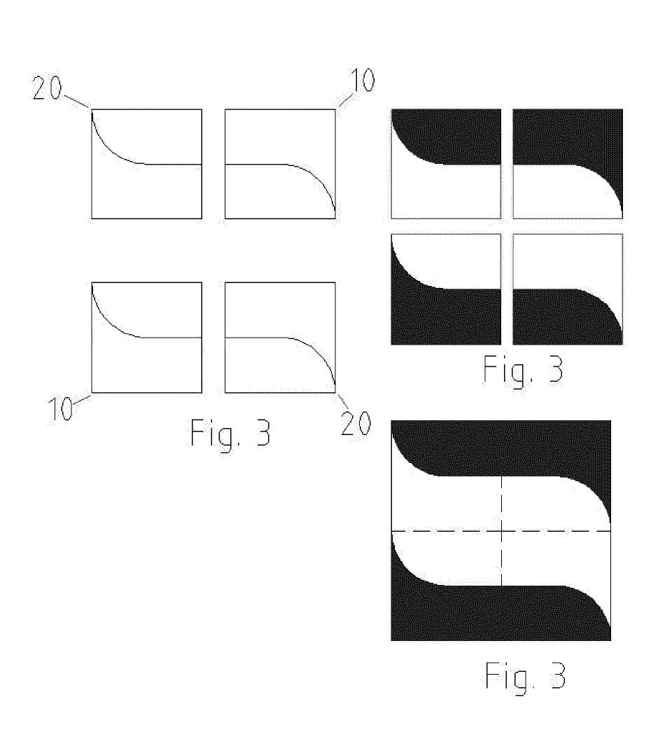

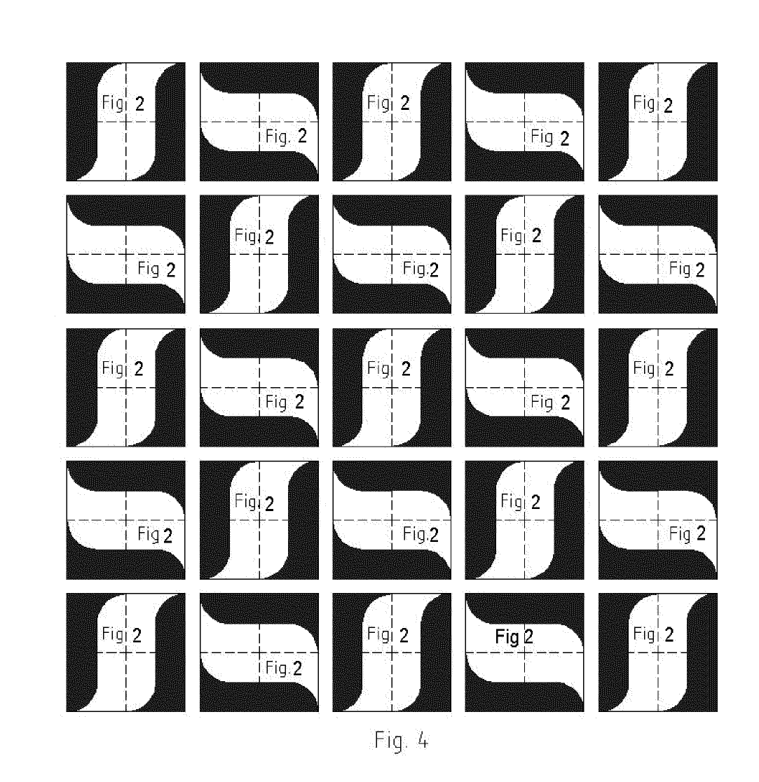

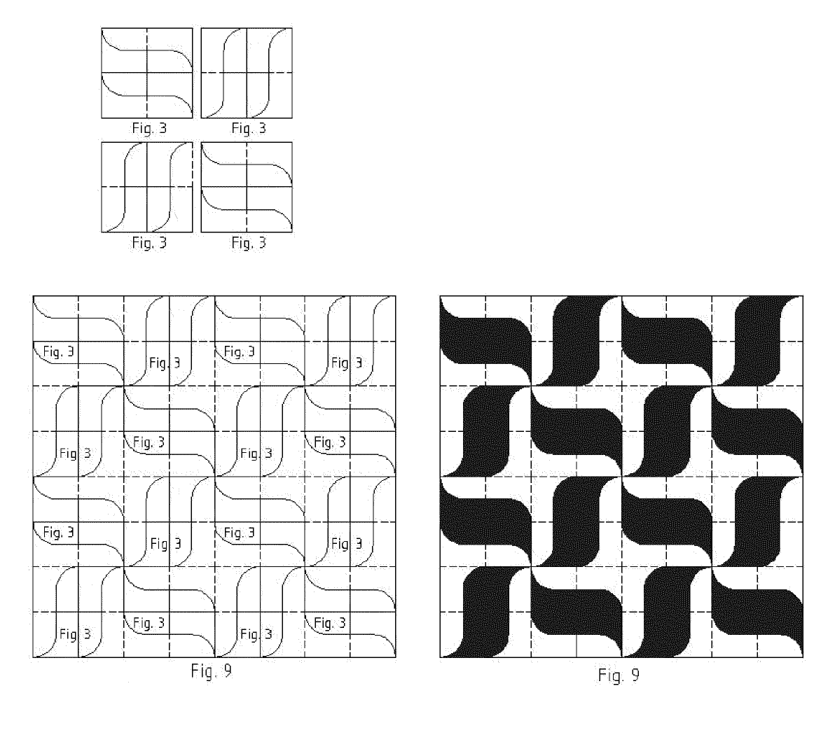

As seen in FIGS. 1-8, the decorative tile kit of the present invention can be manipulated to form at least the following mosaic structures: waves, petals, flowers, fans, tears, or other designs.

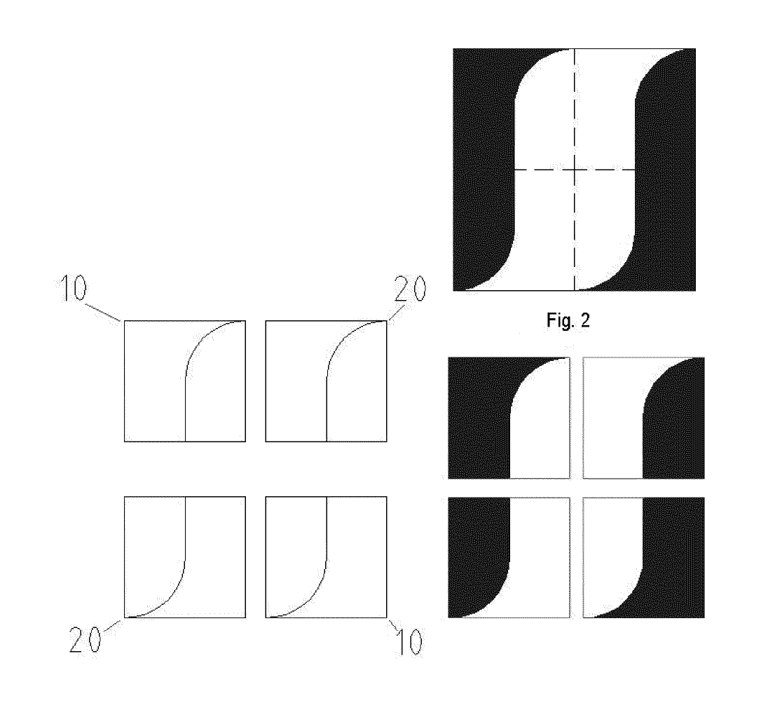

As seen in FIG. 2, the decorative tile kit of the present invention might be arranged as follows: going from top left to bottom left counter clockwise, a first first tile 10, a first second tile 20, a second first tile 10, and a second second tile 20 to form a petal mosaic structure. To form a negative of the petal mosaic structure described in FIG. 2, one simply replaces the first tiles 10 with the second tiles 20 and the second tiles 20 with the first tiles 10 in the arrangement.

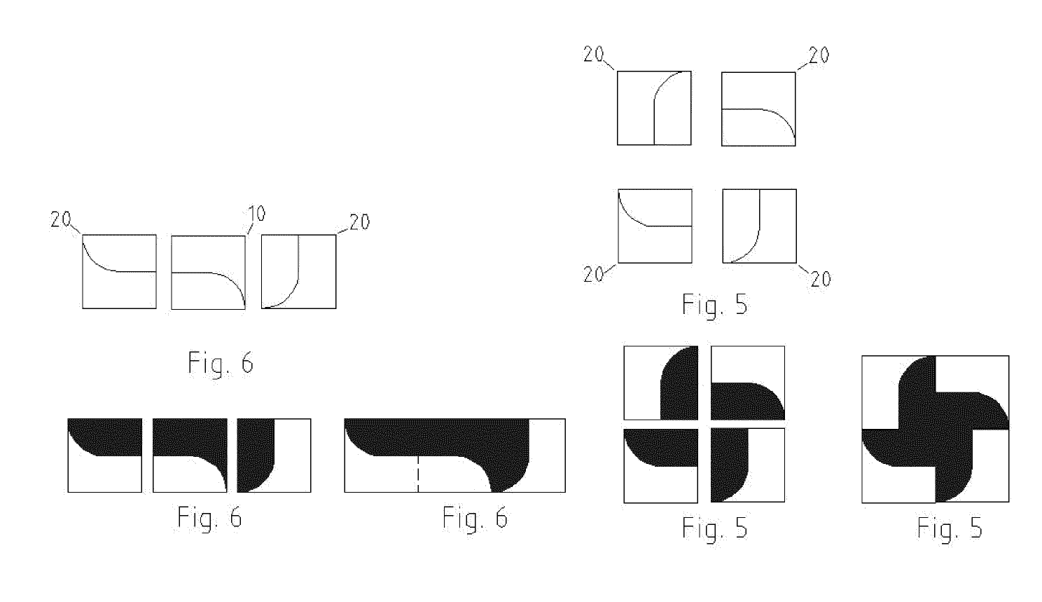

As seen in FIG. 5, the decorative tile kit of the present invention might be arranged as follows: going from top left to bottom left counter clockwise, a first first tile 10, a second first tile 10, a third first tile 10, and fourth first tile 10 to form a flower mosaic structure. To form a negative of the flower mosaic structure described in FIG. 5, one simply replaces the first tiles 10 with the second tiles 20.

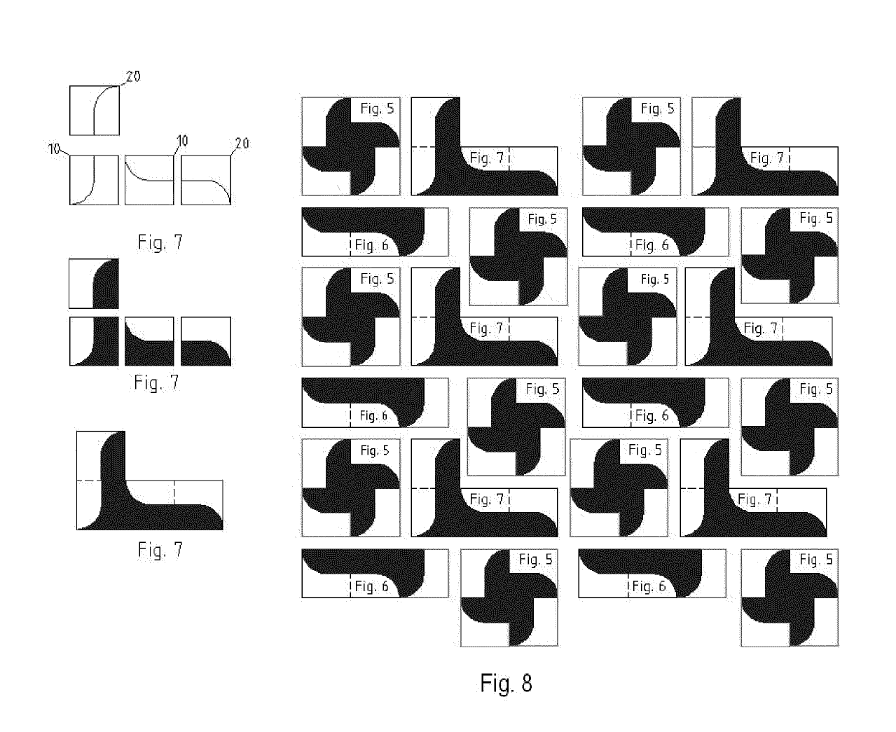

As seen in FIG. 6, the decorative tile kit of the present invention might be arranged as follows: going from left to right linearly, a first second tile 20, a first tile 10, and a second second tile 20 to form a half bell petal mosaic structure. To form a negative of the half bell petal mosaic structure described in FIG. 6, one simply replaces the second tiles 20 with the first tiles 10 and the first tile 10 with the second tile 20 in the arrangement.

An advantage of the present invention is that it provides a decorative tile kit that allows the user to create mosaic patterns on wall or floors.

Another advantage of the present invention is that it provides a decorative tile kit for creating mosaic patterns on walls and floors that is inexpensive to produce.

Although the present invention has been described in considerable detail with reference to certain preferred versions thereof, other versions are possible. Therefore the spirit and the scope of the claims should not be limited to the description of the preferred versions contained herein.

What is claimed is:

1. A decorative tile kit, comprising:
At least a first tile, the first tile has four quadrants, the quadrants are a top right, a top left, a bottom right, and a bottom left, the top left and bottom left quadrants have a first solid physical characteristic, the top right quadrant has a first design having two physical characteristics, the first design is a radius curve that is measured from a bottom right corner of the top right quadrant, the radius curve divides the top right quadrant so that the quadrant has an inner and an outer side with respect to the top right quadrant, the inner side of the top right quadrant has a physical characteristic that is the same as the first solid physical characteristic of the top left and bottom left quadrants, the outer side of the top right quadrant has a second physical characteristic that is different from the first solid physical characteristic, the bottom right quadrant has a solid physical characteristic that is the same as the second physical characteristic of the outer side of the top right quadrant; and
At least a second tile, the second tile has four quadrants, the quadrants are a top right, a top left, a bottom right, and a bottom left, the top left and bottom left quadrants have a third solid physical characteristic, the third solid physical characteristic is the same as the second physical characteristic of the outer side of the top right quadrant of the first tile, the top right quadrant has a second design having two physical characteristics, the second design is a radius curve that is measured from a bottom right corner of the top right quadrant, the radius curve divides the top right quadrant so that the quadrant has an inner and an outer side with respect to the top right quadrant, the inner side of the top right quadrant has a physical characteristic that is the same as the third solid physical characteristic of the top left and bottom left quadrants, the outer side of the top right quadrant has a fourth physical characteristic that is different from the third physical characteristic, yet is the same as the first physical characteristic of the first tile, the bottom right quadrant has a solid physical characteristic that is the same as the fourth physical characteristic of the outer side of the top right quadrant.

2. The decorative tile kit of claim 1, wherein the first and fourth physical characteristics is a first color and wherein the second and third physical characteristics is a second color.

3. The decorative tile kit of claim 1, wherein the first and fourth physical characteristics is a first elevation and wherein the second and third physical characteristics is a second elevation.

4. The decorative tile kit of claim 2, wherein the decorative tile kit is arranged as follows: going from top left to bottom left counter clockwise, a first first tile, a first second tile, a second first tile, and a second second tile to form a petal mosaic structure.

5. The decorative tile kit of claim 2, wherein the decorative tile kit is arranged as follows: going from top left to bottom left counter clockwise, a first first tile, a second first tile, a third first tile, and fourth first tile to form a flower mosaic structure.

6. The decorative tile kit of claim 2, wherein the decorative tile kit is arranged as follows: going from left to right linearly, a first second tile, a first tile, and a second second tile to form a half bell petal mosaic structure.

7. The decorative tile kit of claim 3, wherein the decorative tile kit is arranged as follows: going from top left to bottom left counter clockwise, a first first tile, a first second tile, a second first tile, and a second second tile to form a petal mosaic structure.

8. The decorative tile kit of claim 3, wherein the decorative tile kit is arranged as follows: going from top left to bottom left counter clockwise, a first first tile, a second first tile, a third first tile, and fourth first tile to form a flower mosaic structure.

9. The decorative tile kit of claim 3, wherein the decorative tile kit is arranged as follows: going from left to right linearly, a first second tile, a first tile, and a second second tile to form a half bell petal mosaic structure.
